(19) United States
(12) Patent Application Publication
(10) Pub. No.: US 2005/0067304 A1
(43) Pub. Date: Mar. 31, 2005

(54) Electrode assembly for analysis of metal electroplating solution, comprising self-cleaning mechanism, plating optimization mechanism, and/or voltage limiting mechanism

(76) Inventors: MacKenzie E. King, Southbury, CT (US); Weihua Wang, Bethel, CT (US); Jianwen Han, Danbury, CT (US); Jeffrey F. Roeder, Brookfield, CT (US); Steven M. Lurcott, Sherman, CT (US); Michele Stawasz, New Milford, CT (US)

Correspondence Address: ATMI, INC., 7 COMMERCE DRIVE, DANBURY, CT, 06810, US

(21) Appl. No.: 10/672,433

(22) Filed: Sep. 26, 2003

(51) Int. Cl. G01N 27/26

(52) U.S. Cl. 205/794; 204/434

(57) ABSTRACT

The present invention relates to an electrode assembly useful for analyzing metal electroplating solutions. Such electrode assembly comprises a measuring electrode, preferably a rotating disc electrode or a microelectrode, and at least one of an in situ cleaning mechanism, a nucleation and metal growth optimization mechanism, and a voltage limiting mechanism. The present invention also relates to usage of such electrode assembly for in situ cleaning of the measuring electrode, nucleation and metal growth optimization, or voltage limitation.

### BACKGROUND OF THE INVENTION

1. Field of the Invention

The present invention generally relates to electrode assemblies for analyzing metal electroplating solutions, as well as methods for using same.

2. Background of the Invention

The Pulsed Cyclic Galvanostatic Analysis (PCGA) provides a method for accurately determining the variety and concentration of organic constituents usually contained in metal electrochemical plating baths, such as suppressors, accelerators, and levelers. It is a chrono-potentiometric method wherein the plating currents are set constant, and plating over-potentials are conveniently measured and used to quantify the concentrations of various constituents in the electrochemical plating baths.

In such PCGA analysis, a measuring electrode, preferably a rotating disc electrode (RDE) or a microelectrode, is generally used for measuring analytical signals (i.e., the plating potential or the stripping potential of the solutions) that correlate with the concentrations of various organic additives in a sample metal electroplating solution. The RDE comprises a plating surface for depositing metal thereon, and is coupled with a rotational driver for rotating such RDE at a certain rotation speed. During a PCGA analysis cycle, the RDE is disposed in a measurement chamber, which also comprises an electroplating current source electrode. The metal electroplating solution to be analyzed is introduced into such measurement chamber, and metal is then selectively deposited onto the plating surface of the RDE from the metal electroplating solution at a constant known current density. By measuring the electropotential between the measuring electrode and a reference electrode during the plating process, one can eventually determine the concentration of a specific organic additive in such metal electroplating solution.

One problem involved in such PCGA analysis relates to the presence of surface-active materials in the sample metal electroplating solution, which leads to formation of a surface residual layer on the electrode surface, resulting in electrode passivation or a change in the electrode surface state and causing significant measurement errors after such measuring electrode is used for an extended period of time. Maintenance of a clean, reproducible electrode surface therefore is of critical importance in making meaningful electroanalytical measurements.

Conventionally, various electrode-cleaning devices were implemented for removing the surface residual layer and reactivating the measuring, among which ex situ mechanical polishing of the electrode surface has been proven to be the simplest method. However, deleterious scratching and cleaving of the electrode surface during polishing have significant influence on the electroanalytical measurement results and lead to measurement errors. Moreover, mechanical polishing of the measuring electrode requires removal of such measuring electrode from the measurement chamber, resulting in prolonged system down time and reduced measurement efficiency. Use of power ultrasound, in particular ultrasound transmitted directionally via a horn-type transducer probe, has also been successfully utilized for depassivating the electrode surface via cavitation. However, damages to the electrode surface caused by the cavitation are evident, especially when high ultrasound intensities are employed.

It is therefore an object of the present invention to provide an electrode assembly comprising mechanism for in situ removing the surface residual layer and depassivating the electrode, with significantly shortened system down time and reduced damages to the electrode surface.

Another problem commonly seen in the PCGA analysis relates to lack of uniformity in the metal film plated on the electrode surface, which leads to less reproducible measurement results and increased measurement errors.

Specifically, a PCGA analysis cycle usually comprises two stages: (1) an initial nucleation stage, when a relatively short current pulse is applied to the measuring electrode for forming metal nucleation sites on the electrode surface to facilitate subsequent metal film growth thereon; and (2) a metal growth stage, when a relatively long, constant current pulse is applied to the measuring electrode for growth of a metal film thereon.

However, the conventional PCGA analysis method suffers from irregular metal nucleation sites formed on the electrode surface at the initial nucleation stage, which causes non-uniform metal deposition over the electrode surface during the subsequent metal growth stage and significantly reduces the reproducibility of the measurement results obtained.

It is therefore another object of the present invention to provide an electrode assembly that is capable of forming evenly distributed and high-density nucleation sites throughout the electrode surface during the initial nucleation stage, as well as enabling uniform and reproducible metal deposition thereon during the metal growth stage.

Still another problem involved in the PCGA analysis relates to the lack of control over the electrode potential during the nucleation and metal growth stages, which may result in permanent damages to the electrode device. The PCGA analysis controls only the current applied to the measuring electrode, while allowing the electric potential of the measuring electrode to vary in an uncontrolled manner. However, the oxidation state of the measuring electrode can change significantly, as a function of the electropotential thereon. When such electropotential of the measuring electrode exceeds certain limits (i.e., about 0.7-0.8 V), the electrode surface starts to rearrange, forming cloudy deposits and pores/voids. Such rearrangement of the electrode surface is irreversible and leads to inconsistencies in the PCGA analysis results, which are partially dependent on the surface state of the measuring electrode.

It is therefore a further object of the present invention to provide an electrode assembly having a voltage limiting mechanism, for protecting the measuring electrode against surface rearrangement due to uncontrolled voltage excursions.

Other objects and advantages will be more fully apparent from the ensuring disclosure and appended claims.

### SUMMARY OF THE INVENTION

One aspect of the present invention relates to an electrode assembly for analyzing a sample metal electroplating solution, comprising a measuring electrode and at least one of (1) an in situ cleaning mechanism, (2) a nucleation and metal growth optimization mechanism, and (3) a voltage limiting mechanism.

Specifically, the in situ cleaning mechanism of the present invention comprising an auxiliary electrode, and an auxiliary current source connected to the auxiliary electrode. The measuring electrode can be detachably connected to the auxiliary current source, so that when both the measuring electrode and the auxiliary electrode are immersed in the sample metal electroplating solution or an electrolytic cleaning solution, the auxiliary current source can apply a cycling electric current to the measuring electrode and the auxiliary electrode through the sample metal electroplating solution or the electrolytic cleaning solution, for in situ cleaning and depassivating the measuring electrode.

In a preferred embodiment of the present application, a fresh electrolytic cleaning solution that is free of copper sulfate and organic additives is used during each cleaning cycle for immersing the measuring electrode and the auxiliary electrode. More preferably, such electrolytic cleaning solution comprises sulfuric acid at a concentration of from about 0.1M to about 1M, and most preferably from about 0.1M to about 0.3M. Such electrolytic cleaning solution may further comprise, although not necessarily, potassium sulfate at a concentration of from about 0.1M to about 1M, and more preferably from about 0.3M to about 0.5M. Such electrolytic cleaning solution comprising sulfuric acid, with or without potassium sulfate, is particularly effective in removing surface residues from the measuring electrode with greater precision and efficiency, in comparison to the sample metal electroplating solution that comprises copper sulfate and various organic electroplating additives.

Cycling electric currents characterized by a current cycling range of from about −10 mA/cm\hat{ }2 to about 10 mA/cm\hat{ }2, a cycling rate of from about 0.5 mA/second to about 5 mA/second, and a cycling duration of at least 10 cycles are particularly effective for such cleaning and depassivating purposes.

The nucleation and metal growth optimization mechanism of the present invention comprises a rotation speed controller connected to the measuring electrode. Such rotation speed controller functions to rotate the measuring electrode at various rotation speed during a metal plating/analyzing cycle. Specifically, during an initial nucleation stage of such metal plating/analyzing cycle, the rotation speed controller rotates the measuring electrode at a first predetermined rotation speed, preferably from about 0 to about 10 rpm, and more preferably from about 0 to about 5 rpm, for forming high-density, instantaneous nucleation sites that are evenly distributed throughout the electrode surface. After such initial nucleation stage, the rotation speed controller increases the rotation speed of the measuring electrode to a second predetermined speed, preferably from about 300 to about 2400 rpm, and more preferably from about 500 to about 1250 rpm, which is substantially higher than the first predetermined speed. When rotation of the measuring electrode stabilizes at such second predetermined speed, the rotation speed controller sends an output signal to an electric current source connected with the measuring electrode, for initiation of a subsequent metal growth stage. Metal film growth at the second, higher rotation speed is optimized and uniform throughout the electrode surface, therefore generating reproducible electropotential measurement results and enhancing measurement accuracy.

The voltage limiting mechanism of the present invention comprises a voltage controller for monitoring and controlling electropotential at the electrode surface. When the measured electropotential exceeds a predetermined value, preferably from about 0.7V to about 0.8V, such voltage controller applies an opposite electric current to the measuring electrode for maintaining the electropotential at not more than the predetermined value of about 0.7-0.8V during various stages of a metal plating/analyzing cycle.

Another aspect of the present invention relates to a method for in situ cleaning and depassivating a measuring electrode, comprising the steps of:
(a) providing an electrode assembly that comprises an in situ cleaning mechanism as described hereinabove;
(b) detachably connecting the measuring electrode to the auxiliary current source;
(c) immersing both the measuring electrode and the auxiliary electrode in a sample metal plating solution or an electrolytic cleaning solution;
(d) using the auxiliary current source to apply a cycling electric current to the measuring electrode and the auxiliary electrode through such sample metal plating solution or electrolytic cleaning solution, for a sufficient period of time for in situ cleaning and depassivating the measuring electrode; and
(e) optionally, repeating steps (b)-(d) before each analytical measurement cycle.

Yet another aspect of the present invention relates to a method for optimizing formation of metal nucleation sites and enhancing uniformity of metal film plated on a measuring electrode during a metal plating/analyzing cycle, comprising the steps of:
(a) providing an electrode assembly that comprises a nucleation and metal growth optimization mechanism as described hereinabove;
(b) immersing the measuring electrode of such electrode assembly in a sample metal electroplating solution;
(c) commencing the initial nucleation stage of the metal plating/analyzing cycle, during which the rotation speed controller rotates the measuring electrode at a first predetermined speed;
(d) subsequently, using the rotation speed controller to rotate the measuring at a second predetermined speed that is substantially higher than the first predetermined speed;
(e) after the rotation of the measuring electrode stabilizes at such second predetermined speed, using the rotation speed controller to send an output signal for initiation of a subsequent metal growth stage; and
(f) measuring electropotential of the measuring electrode during the metal growth stage, for determination of concentration of a specific metal additive in the sample electroplating solution.

A still further aspect of the present invention relates to a method for protecting a measuring electrode against surface rearrangement during a metal plating/analyzing cycle, comprising the steps of:
(a) providing an electrode assembly that comprises the voltage limiting mechanism as described hereinabove;
(b) using such voltage limiting mechanism to continuously monitor electropotential at a surface of the measuring during the metal plating/analyzing cycle; and
(c) when the electropotential of the measuring electrode exceeds a predetermined value, using the voltage limiting mechanism to apply an opposite electrode current to the measuring electrode, for maintaining the electropotential of such measuring electrode at not more than the predetermined value during the metal plating/analyzing cycle.

Additional aspects, features and embodiments of the invention will be more fully apparent from the ensuing disclosure and appended claims.

### BRIEF DESCRIPTION OF THE DRAWINGS

FIG. 1 shows the electropotential response measured near the electrode surface of a platinum electrode during a galvanodynamic cleaning cycle, when the electric current cycles from about −0.006 A to about 0.006 A.

FIG. 2 shows the effect of the rotation speed of a measuring electrode on metal nucleation formation on the surface of such measuring electrode.

FIG. 3 shows formation of metal nucleation sites on the surface of a measuring electrode, viewed by atomic force microscopy (AFM), while the rotating speed of such measuring electrode is controlled at about 0 rpm.

FIG. 4 shows a prior art control circuit for a Pulsed Cyclic Galvanostatic Analytic Cell.

FIG. 5 shows an electropotential response curve measured near the electrode surface of a platinum electrode during a metal plating/analyzing cycle.

FIG. 6 shows a voltage limiting circuit for controlling the anodic dissolution potential to less than 0.7V during a cleaning cycle for a platinum electrode, according to one embodiment of the present invention.

### DETAILED DESCRIPTION OF THE INVENTION, AND PREFERRED EMBODIMENTS THEREOF

The present invention provides a novel electrode assembly that is equipped with any or all of a self-cleaning mechanism, a nucleation and metal growth optimization mechanism, and a voltage limiting mechanism, for enhanced measurements results and analytical accuracy.

In the first embodiment of the present invention, the electrode assembly comprises a measuring electrode and a self-cleaning mechanism, which comprises an auxiliary electrode and an auxiliary current sourced connected to such auxiliary electrode, for enabling in situ galvanodynamic cleaning of the passivated measuring electrode.

During a cleaning cycle between the regular metal plating/analyzing cycles, the measuring electrode is detached from a regular measuring circuit used for conducting electroanalytical measurement of a sample metal plating solution and is detachably connected to the auxiliary current source, in such manner that a cycling electric current is passed from the auxiliary current source to the measuring electrode and the auxiliary electrode through either the sample metal plating solution that has been measured, or a fresh electrolytic cleaning solution that comprises sulfuric acid and optionally potassium sulfate. Such cycling electric current oxidizes and/or reduces the surface residue species absorbed on the measuring electrode, and therefore functions to electropolish the measuring electrode. Effective electropolishing can be achieve by a current cycling range of from about −10 mA/cm\hat{ }2 to about 10 mA/cm\hat{ }2, more preferably from about −8 mA/cm\hat{ }2 to about 8 mA/cm\hat{ }2, and most preferably from about −6 mA/cm\hat{ }2 to about 6 mA/cm\hat{ }2. Within the same cycling range, such electric current concurrently generates multiple hydrogen and oxygen micro-bubbles on the electrode surface, and therefore provides a vigorous surface process that functions to peel away any non-oxidizable or non-reducible solid or liquid residues on the electrode surface that may passivate the measuring electrode.

The cycling electric current therefore performs the dual function of electropolishing and cavitating the measuring electrode, and provides a reliable, reproducible, and robust electrode surface for subsequent electroanalytical measurements.

The measuring electrode and the auxiliary electrode preferably comprise metal or metal alloys, such as platinum, stainless steel, copper, aluminum, gold, silver, etc., and alloys thereof, and more preferably the measuring electrode has a platinum tip. However, such measuring electrode and auxiliary electrode are not limited thereby in any manner, and they can also comprise carbon, glass, ceramic, and any other metal and/or non-metal materials suitable for manufacturing electrodes, depending on the specific uses they are intended for. For example, when the electrodes are used for measuring oxidation-reduction-potential in a sample solution, such electrodes preferably comprise platinum or platinum alloys; when the electrodes are used for measuring pH value of the sample solution, they preferably comprise glass.

The measuring electrode, the auxiliary electrode, and the auxiliary current source are preferably integrated into a unitary module. More preferably, the measuring electrode is detachably connected to the auxiliary current source by a switching device at the beginning of each cleaning cycle, and is detached from such auxiliary current course after completion of the cleaning cycle and subsequently connected to a measuring circuit for conducting electroanalytical measurement of the sample metal plating solution.

Use of fresh electrolytic cleaning solution comprises sulfuric acid and/or potassium sulfate during the cleaning cycles provides enhanced cleaning efficiency and improved precision in residue removal, without causing significant damage to the electrode surface. An electrolytic cleaning solution comprising sulfuric acid and potassium sulfate, which is substantially free of copper sulfate and organic electroplating additives, is preferably employed for practicing the present invention. The concentration of sulfuric acid in the electrolytic cleaning solution is preferably within a range of from about 0.1M to about 1M, more preferably from about 0.1M to about 0.3M, and most preferably about 0.2M. The concentration of potassium sulfate in such cleaning solution is preferably within a range of from about 0.1M to about 1M, more preferably from about 0.3M to about 0.5M, and most preferably about 0.4M.

The cycling rate of the electric current is preferably within the range of from about 1 mA/second to about 3 mA/second, and is more preferably about 2 mA/second.

The cycling duration is preferably at least 15 cycles, and more preferably at least 20 cycles, and most preferably at least 30 cycles.

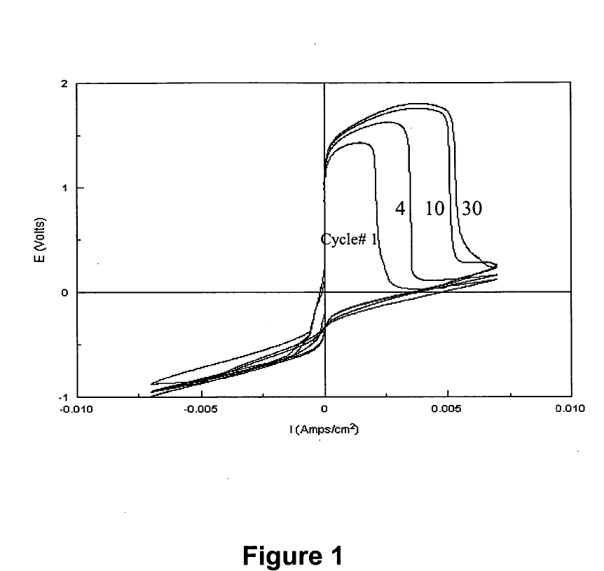

FIG. 1 shows the electropotential response of a platinum measuring electrode during a cleaning cycle after prolonged use for analyzing copper plating solutions. The cleaning current cycles from about −6 mA/cm\hat{ }2 to about 6 mA/cm\hat{ }2, at a cycling rate of about 2 mA/second and for 30 cycles (about 7 minutes).

As can be seen, repeated cycling of the electric current causes the electropotential measured by the measuring electrode to reach an asymptotic limit, indicating that the electrode surface has been satisfactorily cleaned.

Grazing angle measurements by Fourier Transform-Infrared (FT-IR) techniques corroborate the fact that the organic residues on the electrode surface of such measuring electrode has been effectively removed, and the scanning electron microscopic (SEM) images of the platinum tip of the measuring electrode shows that the measuring electrode has been effectively electroplished.

Therefore, the electrode assembly of the present invention is effective in in situ depassivating or rejuvenating a measuring electrode and preparing such for subsequent electroanalytical measurements of the metal electroplating solutions.

In another embodiment of the present invention, the electrode assembly comprises a measuring electrode and a nucleation and metal growth optimization mechanism.

In the Pulsed Galvanostatic Cyclic Analysis (PGCA) of metal plating solutions, a constant current is applied to a measuring electrode in two phases: (1) a relatively shorter current pulse for forming metal nucleation sites on the electrode surface, which is generally referred to as the initial nucleation stage, and (2) a relatively longer current pulse for enabling steady growth of metal film on the measuring electrode, which is generally referred to as the metal growth stage.

In conventional PGCA analysis, the measuring electrode is rotated during both the initial nucleation stage and the subsequent metal growth stage. However, the metal film grown during such conventional PGCA process is not evenly distributed over the electrode surface, resulting in irreproducible electropotential responses and irregular electropotential spikes, which significantly reduces the reproducibility of the measurement results and increases possible measurement errors.

Various methods have been used to optimize the nucleation and metal growth, but none is effective in ensuring a uniform growth of the metal film and increasing the reproducibility of the measurement results.

Inventors of the present invention have discovered that (1) instantaneously-formed and uniformly-distributed metal nucleation sites are required for a more reproducible metal growth stage, (2) both the nucleation process and the metal growth process are significantly influenced by the electrode rotation speed.

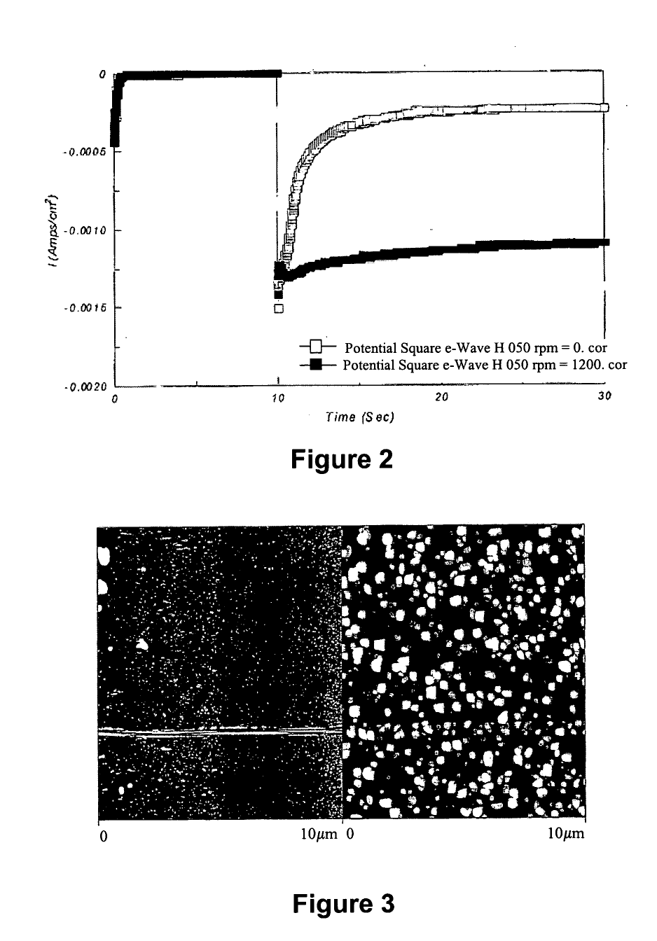

More specifically, it has been discovered that an immobile electrode surface or an electrode surface rotating at low speed enables instantaneous and uniform formation of metal nuclei over such electrode surface. FIG. 2 shows the effect of rotation speed on nucleation on the electrode surface. FIG. 3 contains atomic force microscopy (AFM) images of an electrode surface, as taken before (left) and after (right) the initial nucleation stage in which the measuring electrode is not rotated, which show that the metal nucleation sites so formed are evenly distributed over the electrode surface.

On the other hand, rotation of the electrode surface at a significant rotation speed enhances mass transfer of the metal electroplating solution over the electrode surface, which is required for forming a uniform and reproducible metal film thereon.

Therefore, the nucleation and metal growth can be effectively optimized by first forming instantaneous and uniformly-distributed metal nucleation sites on the electrode surface while controlling the rotation speed of the measuring electrode at about 0 to about 10 rounds per minute (rpm), then starting to rotate the measuring electrode at a relatively high rotating speed, i.e., from about 300 to about 2400 rpm, and after the rotation of the measuring electrode at such relatively high speed becomes stable, beginning the metal growth stage by applying a long current pulse to the measuring electrode. Measurement of the plating potential for analysis and determination of the additive concentration of the sample metal plating solutions is carried out during such metal growth stage, in which a uniform and reproducible metal film is deposited over the measuring electrode surface.

The present invention specifically employs a rotating speed controller as a nucleation and metal growth optimization mechanism, which is connected with the measuring electrode for varying the rotation speed of the measuring electrode during the initial nucleation stage and the subsequent metal growth stage, so as to optimize formation of the metal nucleation sites and growth of the metal film over the electrode surface. During the initial nucleation stage, the rotation speed controller effectuates rotation of the measuring electrode at a relatively lower speed, i.e., from about 0 to about 10 rpm. After such initial nucleation stage, the rotation speed controller effectuates rotation of such measuring electrode at a relatively higher speed, i.e., from about 300 to about 2400 rpm, and more preferably from about 500 to about 1250 rpm. When the rotation of the RDE at such relatively higher speed stabilizes, the rotation speed controller sends an output signal to the main measuring circuit of the measuring electrode for initiation of the metal growth stage.

Further, in conventional PCGA process, a constant electric current is applied to the measuring electrode, while the voltage of the measuring electrode is allowed to vary in an uncontrolled manner during various stages of the metal plating/analyzing cycles, such as the stripping, the analyzing, and the surface preparation stages.

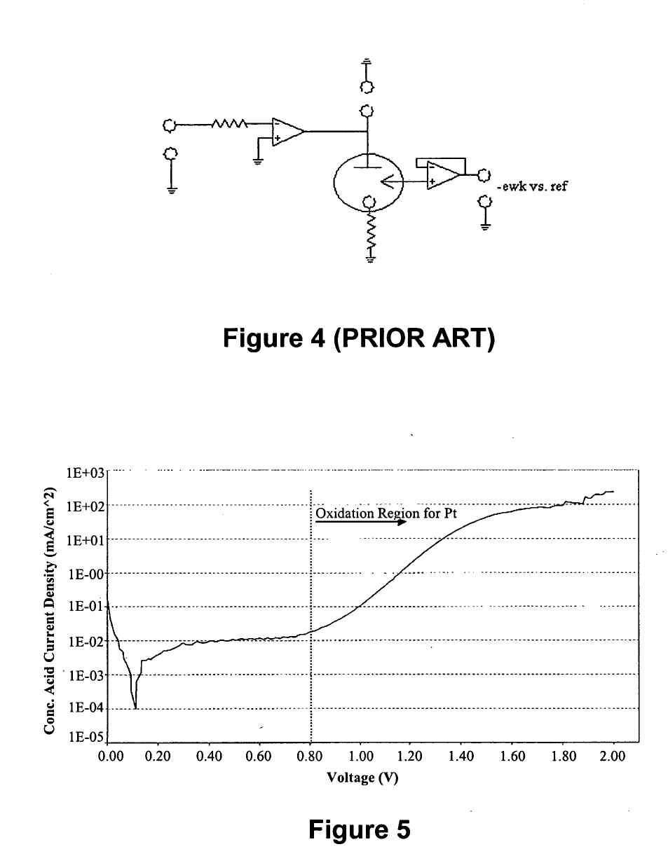

However, if the voltage of the measuring electrode exceeds certain limits, the electrode surface starts to change dramatically, which is caused by the change of the equilibrium or oxidation state of the metal electrode surface as a result of the applied electropotential. Changes in the electrode surface lead to inconsistencies in the measurement results and subsequent analysis thereof, and result insignificant measurement errors. FIG. 4 shows the voltage vs. current scan response curve of a platinum electrode in a low acid copper plating solution. When the voltage of the electrode reaches 0.7V (in relation to the Ag/AgCl reference electrode), the platinum starts to oxidize, forming cloudy deposits and pores/voids of significant sizes on the electrode surface.

However, the conventional PCGA measuring circuit connected with the measuring electrode, as shown in FIG. 5 for illustration purpose, does not comprise any voltage limiting mechanism for protecting such electrode surface against oxidation and rearrangement.

Alternative plating solution analysis methods, such as the cyclic voltammetric spectroscopy (CVS), avoids the surface rearrangement problem, by controlling the voltage. However, the CVS method suffers form numerous deficiencies in comparison with the PCGA method, and the PCGA analysis is generally preferred for analysis of multicomponent plating solutions.

Accordingly, it will be highly desirable to provide a PCGA method in which the surface rearrangement is either completely suppressed or partially reduced.

The present invention therefore in still another embodiment provides an assembly for conducting PCGA analysis, which comprises a voltage limiting mechanism, so as to avoid uncontrolled voltage excursions or prolonged high voltages that may irreversibly change the measuring electrode surface state in the current control PCGA platform for metal plating solution analysis.

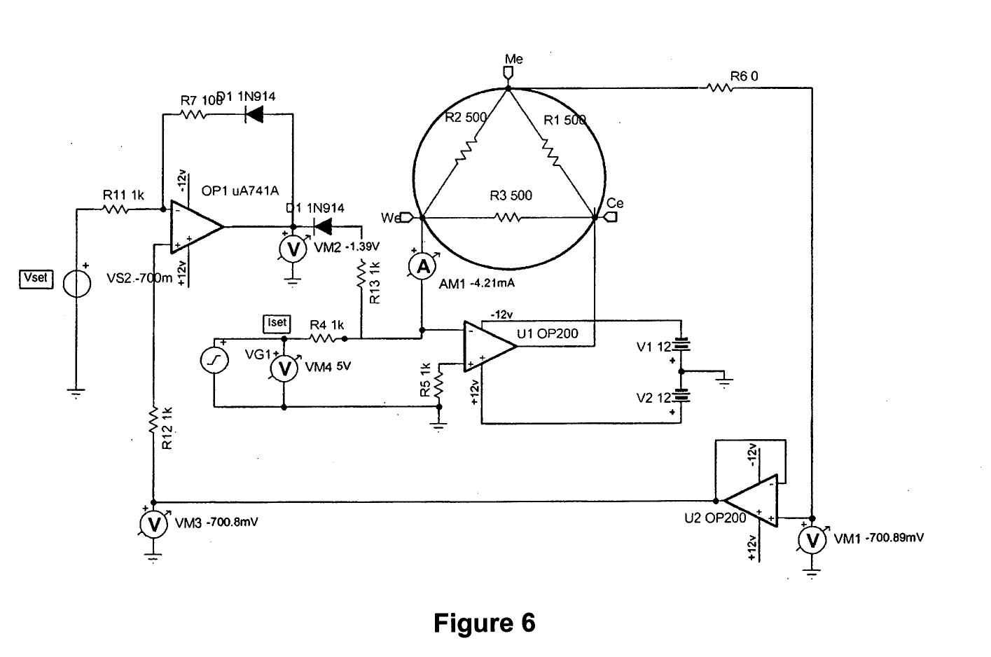

Specifically, such voltage limiting mechanism comprises a voltage controller or a voltage limiting circuit, which comprises simple elements and operate in a passive mode or an active feedback mode to control the electropotential at the electrode surface during various stages of a PCGA measurement cycle. Preferably, the present invention incorporates an analog feedback circuit into the conventional current control circuit of FIG. 5, forming a voltage limiting circuit, as shown in FIG. 6. Such voltage limiting circuit constantly senses and monitors the voltage at the electrode surface. When such voltage exceeds about 0.7V, such voltage limiting circuit applies an opposite current to the non-inverting terminal of the current source op amp, so that the overall current applied to the measuring electrode is limited, and the maximum electropotential created by the overall current is therefore controlled to about 0.7V-0.8V, which effectively prevents the surface rearrangement of the measuring electrode.

The voltage limiting circuit as shown in FIG. 6 is provided for illustrative purpose only and is not intended to be used for limiting the broad scope of the present invention. It may be readily modified by a person ordinarily skilled in the art and may further comprise various known software, hardware, or firmware in actual implementation, and such modified voltage limiting circuit is within the scope of the present invention.

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art. The invention therefore is to be broadly construed, consistent with the claims hereafter set forth.

1. An electrode assembly for analyzing a sample metal electroplating solution, comprising a measuring electrode and at least one of (1) an in situ cleaning mechanism, (2) a nucleation and metal growth optimization mechanism, and (3) a voltage limiting mechanism,
said in situ cleaning mechanism comprising an auxiliary electrode and an auxiliary current source connected to said auxiliary electrode, wherein the measuring electrode is detachably connectable to said auxiliary current source, so that when both the measuring electrode and the auxiliary electrode are immersed in a sample metal electroplating solution or an electrolytic cleaning solution, the auxiliary current source applies a cycling electric current to the measuring electrode and the auxiliary electrode through said sample metal electroplating solution or electrolytic cleaning solution, for in situ cleaning and depassivating the measuring electrode;
said nucleation and metal growth optimization mechanism comprising a rotation speed controller, which is connected to the measuring electrode for rotating the measuring electrode at various rotation speeds during a metal plating/analyzing cycle, wherein during an initial nucleation stage, said rotation speed controller effectuates rotation of the measuring electrode at a first predetermined speed, wherein after said initial nucleation stage, said rotation speed controller effectuates rotation of the measuring electrode at a second predetermined speed that is substantially higher than the first predetermined speed, and wherein said rotation speed controller sends an output signal for initiation of a subsequent metal growth stage when the rotation of the measuring electrode at said second predetermined speed stabilizes; and
said voltage limiting mechanism comprising a voltage controller for monitoring electropotential at a surface of the measuring electrode and for applying an opposite electric current to the measuring electrode when the electropotential exceeds a predetermined value, so that said electropotential is maintained at not more than said predetermined value during various stages of a metal plating/analyzing cycle.

2. The electrode assembly of claim 1, comprising said in situ cleaning mechanism.

3. The electrode assembly of claim 2, wherein both the measuring electrode and the auxiliary electrode are immersed in an electrolytic cleaning solution comprising sulfuric acid and optionally potassium sulfate, and wherein the auxiliary current source applies a cycling electric current to the measuring electrode and the auxiliary electrode through said electrolytic cleaning solution, for in situ cleaning and depassivating the measuring electrode.

4. The electrode assembly of claim 3, wherein said electrolytic cleaning solution is substantially free of copper sulfate and organic additives.

5. The electrode assembly of claim 3, wherein said electrolytic cleaning solution comprises sulfuric acid at a concentration in a range of from about 0.1M to about 1M.

6. The electrode assembly of claim 5, wherein said electrolytic cleaning solution further comprises potassium sulfate at a concentration in a range of from about 0.1M to about 1M.

7. The electrode assembly of claim 3, wherein said electrolytic cleaning solution comprises sulfuric acid at a concentration in a range of from about 0.1M to about 0.3M.

8. The electrode assembly of claim 7, wherein said electrolytic cleaning solution further comprises potassium sulfate at a concentration in a range of from about 0.3M to about 0.5M.

9. The electrode assembly of claim 2, wherein the cycling electric current applied by said auxiliary current source is characterized by a current cycling range of from about −10 mA/cm\hat{ }2 to about 10 mA/cm\hat{ }2, a cycling rate of from about 0.5 mA/second to about 5 mA/second, and a cycling duration of at least 10 cycles.

10. The electrode assembly of claim 2, wherein the measuring electrode, the auxiliary electrode, and the auxiliary current source are integrated into a unitary module.

11. The electrode assembly of claim 2, wherein said electric current cycles from about −8 mA/cm\hat{ }2 to about 8 mA/cm\hat{ }2.

12. The electrode assembly of claim 2, wherein said electric current cycles from about −6 mA/cm\hat{ }2 to about 6 mA/cm\hat{ }2.

13. The electrode assembly of claim 2, wherein said electric current has a cycling rate in the range of from about 1 mA/second to about 3 mA/second.

14. The electrode assembly of claim 2, wherein said electric current has a cycling rate of about 2 mA/second.

15. The electrode assembly of claim 2, wherein said cycling electric current is provided for at least 15 cycles.

16. The electrode assembly of claim 2, wherein said cycling electric current is provided for at least 20 cycles.

17. The electrode assembly of claim 2, wherein said cycling electric current is provided for at least 30 cycles.

18. The electrode assembly of claim 1, comprising said nucleation and metal growth optimization mechanism, wherein the first predetermined speed is in a range of from about 0 to about 10 rpm, and wherein the second predetermined speed is in a range of from about 300 to about 2400 rpm.

19. The electrode assembly of claim 18, wherein the first predetermined speed is in a range of from about 0 to about 5 rpm, and wherein the second predetermined speed is in a range of from about 500 to about 1250 rpm.

20. The electrode assembly of claim 1, comprising said voltage limiting mechanism, wherein said voltage controller comprises an analog feedback circuit connected with said measuring electrode.

21. The electrode assembly of claim 20, wherein said predetermined value is within a range of from about 0.7V to about 0.8V.

22. A method for in situ cleaning and depassivating a measuring electrode, comprising the steps of:
(a) providing an electrode assembly as in claim 1, wherein said electrode assembly comprises the in situ cleaning mechanism;
(b) detachably connecting the measuring electrode to the auxiliary current source;
(c) immersing both the measuring electrode and the auxiliary electrode in a sample metal plating solution or an electrolytic cleaning solution;
(d) using said auxiliary current source to apply a cycling electric current to the measuring electrode and the auxiliary electrode through said sample metal plating solution or electrolytic cleaning solution, for a sufficient period of time for in situ cleaning and depassivating the measuring electrode; and
(e) optionally, repeating steps (b)-(d) before each analytical measurement cycle.

23. The method of claim 22, wherein both the measuring electrode and the auxiliary electrode are immersed in an electrolytic cleaning solution comprising sulfuric acid and optionally potassium sulfate, and wherein the auxiliary current source applies a cycling electric current to the measuring electrode and the auxiliary electrode through said electrolytic cleaning solution, for in situ cleaning and depassivating the measuring electrode.

24. The method of claim 23, wherein said electrolytic cleaning solution is substantially free of copper sulfate and organic additives.

25. The method of claim 23, wherein said electrolytic cleaning solution comprises sulfuric acid at a concentration in a range of from about 0.1M to about 1M.

26. The method of claim 25, wherein said electrolytic cleaning solution further comprises potassium sulfate at a concentration in a range of from about 0.1M to about 1M.

27. The method of claim 23, wherein said electrolytic cleaning solution comprises sulfuric acid at a concentration in a range of from about 0.1M to about 0.3M.

28. The method of claim 27, wherein said electrolytic cleaning solution further comprises potassium sulfate at a concentration in a range of from about 0.3M to about 0.5M.

29. The method of claim 22, wherein the cycling electric current applied by said auxiliary current source is characterized by a current cycling range of from about −10 mA/cm\hat{ }2 to about 10 mA/cm\hat{ }2, a cycling rate of from about 0.5 mA/second to about 5 mA/second, and a cycling duration of at least 10 cycles.

30. The method of claim 29, wherein said electric current cycles from about −8 mA/cm\hat{ }2 to about 8 mA/cm\hat{ }2.

31. The method of claim 29, wherein said electric current cycles from about −6 mA/cm\hat{ }2 to about 6 mA/cm\hat{ }2.

32. The method of claim 29, wherein said electric current has a cycling rate in the range of from about 1 mA/second to about 3 mA/second.

33. The method of claim 29, wherein said electric current has a cycling rate of about 2 mA/second.

34. The method of claim 29, wherein said cycling electric current is provided for at least 15 cycles.

35. The method of claim 29, wherein said cycling electric current is provided for at least 20 cycles.

36. The method of claim 29, wherein said cycling electric current is provided for at least 30 cycles.

37. A method for optimizing formation of metal nucleation sites and enhancing uniformity of metal film plated on a measuring electrode during a metal plating/analyzing cycle, comprising the steps of:
(a) providing an electrode assembly as in claim 1, wherein said electrode assembly comprises the nucleation and metal growth optimization mechanism;
(b) immersing said measuring electrode in a sample metal electroplating solution;
(c) commencing the initial nucleation stage of the metal plating/analyzing cycle, during which the rotation speed controller rotates the measuring electrode at a first predetermined speed;
(d) subsequently, using the rotation speed controller to rotate the measuring electrode at a second predetermined speed that is substantially higher than the first predetermined speed;
(e) after the rotation of the measuring electrode stabilizes at said second predetermined speed, using the rotation speed controller to send an output signal for initiation of a subsequent metal growth stage; and
(f) measuring electropotential of the measuring electrode during the metal growth stage, for determination of concentration of a specific metal additive in said sample electroplating solution.

38. The method of claim 37, wherein the first predetermined speed is in a range of from about 0 to about 10 rpm, and wherein the second predetermined speed is in a range of from about 300 to about 2400 rpm.

39. The method of claim 37, wherein the first predetermined speed is in a range of from about 0 to about 5 rpm, and wherein the second predetermined speed is in a range of from about 500 to about 1250 rpm.

40. A method for protecting a measuring electrode against surface rearrangement during a metal plating/analyzing cycle, comprising the steps of:
(a) providing an electrode assembly as in claim 1, wherein said electrode assembly comprises the voltage limiting mechanism;
(b) using said voltage limiting mechanism to continuously monitor electropotential of the measuring electrode during said metal plating/analyzing cycle; and
(c) when the electropotential of the measuring electrode exceeds a predetermined value, using said voltage limiting mechanism to apply an opposite electrode current to the measuring electrode, for maintaining the electropotential of such measuring electrode at not more than said predetermined value during the metal plating/analyzing cycle.

41. The method of claim 40, wherein said voltage controller comprises an analog feedback circuit connected with said measuring electrode.

42. The method of claim 40, wherein said predetermined value is within the range of from about 0.7V to about 0.8V.
